(19) United States
(12) Patent Application Publication
(10) Pub. No.: US 2024/0227827 A9
(43) Pub. Date: Jul. 11, 2024

(54) METHOD AND SYSTEM FOR AUTOMATICALLY TAKING AN ACTION UPON DETECTING A FAULT IN A VEHICLE

(71) Applicant: Volvo Car Corporation, Göteborg (SE)

(72) Inventors: Matthias Yannick Philippe Le Saux, Göteborg (SE); Casper Wickman, Öckerö (SE); Mikael Tormanen, Göteborg (SE)

(21) Appl. No.: 17/972,631

(22) Filed: Oct. 25, 2022

(51) Int. Cl. B60W 50/029; B60K 35/00; B60W 40/02; B60W 50/02; B60W 50/14; G06N 20/00

(52) U.S. Cl. CPC B60W 50/029; B60K 35/00; B60W 40/02; B60W 50/0205; B60W 50/14; G06N 20/00; B60K 2370/161; B60W 2050/021; B60W 2050/0215; B60W 2050/146; B60W 2556/45

(57) ABSTRACT

A method and system for automatically taking an action upon detecting a fault in a vehicle. An artificial intelligence (AI) system disposed in or in communication with the vehicle assists the operator of the vehicle based on a knowledge of what steps are needed when a given fault is detected in the vehicle. Some such steps may be taken before the AI system interacts with the operator of the vehicle, thereby minimizing operator effort. The AI system identifies the fault; diagnoses a source, nature, and cause of the fault; retrieves and/or generates steps necessary to fix the problem causing the fault; automatically takes any appropriate initial steps to fix the problem causing the fault; alerts the operator of the vehicle to the fault; and communicates to the operator of the vehicle any appropriate remaining steps that the operator of vehicle should take to fix the problem causing the fault.

### TECHNICAL FIELD

The present disclosure relates generally to the automotive field. More particularly, the present disclosure relates to a method and system for automatically taking an action upon detecting a fault in a vehicle.

### BACKGROUND

When an electronic control unit (ECU) or other processing system detects a fault in a vehicle, indicating that something is wrong or needs attention, an alert is typically displayed to an operator of the vehicle. For example, the ECU or other processing system may detect that a tire pressure is low, a fluid level is low, there is an engine issue, a headlight is malfunctioning, a safety feature is disabled, or the like and issue an appropriate alert to the operator of the vehicle. In order to fix the problem, the operator of the vehicle typically needs to take action, but may not understand exactly what to do, forcing the operator of the vehicle to consult an owner's manual or online resource to determine what a given alert means and what action is needed. This is a cumbersome and inefficient process, delaying a fix to a problem experienced.

This background is provided as illustrative environmental context only and is not intended to be limiting in any manner. It will be readily apparent to those of ordinary skill in the art that the concepts and principles of the present disclosure may be implemented in other environmental contexts equally.

### SUMMARY

The present disclosure provides a method and system for automatically taking an action upon detecting a fault in a vehicle. An artificial intelligence (AI) system disposed in or in communication with the vehicle assists the operator of the vehicle based on a knowledge of what steps are needed when a given fault is detected in the vehicle. Some such steps may be taken before the AI system interacts with the operator of the vehicle, thereby minimizing operator effort. When a fault in the vehicle is detected, the AI system identifies the fault; diagnoses a source, nature, and cause of the fault; retrieves and/or generates steps necessary to fix the problem causing the fault; automatically takes any appropriate initial steps to fix the problem causing the fault; alerts the operator of the vehicle to the fault; and communicates to the operator of the vehicle any appropriate remaining steps that the operator of vehicle should take to fix the problem causing the fault.

In one illustrative embodiment, the present disclosure provides a method for automatically taking an action upon detecting a fault in a vehicle, the method including: receiving an indication of the fault from a sensor of the vehicle; at an artificial intelligence system associated with the vehicle, identifying the fault; at the artificial intelligence system associated with the vehicle, diagnosing one or more of a source of the fault, a nature of the fault, and a cause of the fault; at the artificial intelligence system associated with the vehicle, retrieving or generating steps to address a problem causing the fault; at the artificial intelligence system associated with the vehicle, controlling a vehicle system to take any initial steps to address the problem causing the fault; via the artificial intelligence system associated with the vehicle and a display, alerting an operator of the vehicle of the fault; and, via the artificial intelligence system associated with the vehicle and the display, communicating to the operator of the vehicle any remaining steps to address the problem causing the fault that should be taken by the operator of the vehicle. The artificial intelligence system one of: uses a lookup table including faults and steps to address problems causing the faults; and is trained using faults and steps to address the problems causing the faults. The display includes one or more of a display of the vehicle and a display of a mobile device associated with the operator of the vehicle. The method further includes, at the artificial intelligence system associated with the vehicle, receiving an instruction from the operator of the vehicle related to carrying out a remaining step to address the problem causing the fault. The method further includes, via the artificial intelligence system associated with the vehicle, after receiving the instruction from the operator of the vehicle related to carrying out the remaining step to address the problem causing the fault, communicating details associated with the fault to a third party via a communication link. Optionally, communicating to the operator of the vehicle a remaining step to address the problem causing the fault includes communicating to the operator of the vehicle a location of a preferred service station identified by the artificial intelligence system associated with the vehicle via a navigation system of one or more of the vehicle and a mobile device. The preferred service station is identified taking into account one or more of services available at the preferred service station, proximity of the preferred service station to the vehicle, proximity of the preferred service station to a destination of the vehicle received from the operator of the vehicle, a determined severity of the fault, a determined fuel or charge range of the vehicle, an available time received from the operator of the vehicle, current road conditions, current traffic conditions, and current weather conditions.

In another illustrative embodiment, the present disclosure provides a non-transitory computer-readable medium including instructions stored in a memory and executed by a processor to carry out steps for automatically taking an action upon detecting a fault in a vehicle, the steps including: receiving an indication of the fault from a sensor of the vehicle; at an artificial intelligence system associated with the vehicle, identifying the fault; at the artificial intelligence system associated with the vehicle, diagnosing one or more of a source of the fault, a nature of the fault, and a cause of the fault; at the artificial intelligence system associated with the vehicle, retrieving or generating steps to address a problem causing the fault; at the artificial intelligence system associated with the vehicle, controlling a vehicle system to take any initial steps to address the problem causing the fault; via the artificial intelligence system associated with the vehicle and a display, alerting an operator of the vehicle of the fault; and, via the artificial intelligence system associated with the vehicle and the display, communicating to the operator of the vehicle any remaining steps to address the problem causing the fault that should be taken by the operator of the vehicle. The artificial intelligence system one of: uses a lookup table including faults and steps to address problems causing the faults; and is trained using faults and steps to address the problems causing the faults. The display includes one or more of a display of the vehicle and a display of a mobile device associated with the operator of the vehicle. The steps further include, at the artificial intelligence system associated with the vehicle, receiving an instruction from the operator of the vehicle related to carrying out a remaining step to address the problem causing the fault. The steps further include, via the artificial intelligence system associated with the vehicle, after receiving the instruction from the operator of the vehicle related to carrying out the remaining step to address the problem causing the fault, communicating details associated with the fault to a third party via a communication link. Optionally, communicating to the operator of the vehicle a remaining step to address the problem causing the fault includes communicating to the operator of the vehicle a location of a preferred service station identified by the artificial intelligence system associated with the vehicle via a navigation system of one or more of the vehicle and a mobile device. The preferred service station is identified taking into account one or more of services available at the preferred service station, proximity of the preferred service station to the vehicle, proximity of the preferred service station to a destination of the vehicle received from the operator of the vehicle, a determined severity of the fault, a determined fuel or charge range of the vehicle, an available time received from the operator of the vehicle, current road conditions, current traffic conditions, and current weather conditions.

In a further illustrative embodiment, the present disclosure provides a system for automatically taking an action upon detecting a fault in a vehicle, the system including: a sensor of the vehicle operable for sensing the fault; and an artificial intelligence system associated with the vehicle operable for: identifying the fault sensed by the sensor of the vehicle; diagnosing one or more of a source of the fault, a nature of the fault, and a cause of the fault; retrieving or generating steps to address a problem causing the fault; controlling a vehicle system to take any initial steps to address the problem causing the fault; via a display, alerting an operator of the vehicle of the fault; and, via the display, communicating to the operator of the vehicle any remaining steps to address the problem causing the fault that should be taken by the operator of the vehicle. The artificial intelligence system one of: uses a lookup table including faults and steps to address problems causing the faults; and is trained using faults and steps to address the problems causing the faults. The display includes one or more of a display of the vehicle and a display of a mobile device associated with the operator of the vehicle. The artificial intelligence system associated with the vehicle is further operable for receiving an instruction from the operator of the vehicle related to carrying out a remaining step to address the problem causing the fault. The artificial intelligence system associated with the vehicle is further operable for, after receiving the instruction from the operator of the vehicle related to carrying out the remaining step to address the problem causing the fault, communicating details associated with the fault to a third party via a communication link. Optionally, communicating to the operator of the vehicle a remaining step to address the problem causing the fault includes communicating to the operator of the vehicle a location of a preferred service station identified by the artificial intelligence system associated with the vehicle via a navigation system of one or more of the vehicle and a mobile device. The preferred service station is identified taking into account one or more of services available at the preferred service station, proximity of the preferred service station to the vehicle, proximity of the preferred service station to a destination of the vehicle received from the operator of the vehicle, a determined severity of the fault, a determined fuel or charge range of the vehicle, an available time received from the operator of the vehicle, current road conditions, current traffic conditions, and current weather conditions.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a schematic diagram illustrating one embodiment of the vehicle fault detection and mitigation system of the present disclosure;

FIG. 2 is a schematic diagram illustrating one embodiment of vehicle fault detection and mitigation method of the present disclosure;

FIG. 3 is a network diagram of a cloud-based system for implementing the various algorithms and functions of the present disclosure;

FIG. 4 is a block diagram of a server that may be used in the cloud-based system of FIG. 3 or stand-alone; and

FIG. 5 is a block diagram of a user device that may be used in the cloud-based system of FIG. 3 or stand-alone.

### DETAILED DESCRIPTION

Again, the present disclosure provides a method and system for automatically taking an action upon detecting a fault in a vehicle. An AI system disposed in or in communication with the vehicle assists the operator of the vehicle based on a knowledge of what steps are needed when a given fault is detected in the vehicle. Some such steps may be taken before the AI system interacts with the operator of the vehicle, thereby minimizing operator effort. When a fault in the vehicle is detected, the AI system identifies the fault; diagnoses a source, nature, and cause of the fault; retrieves and/or generates steps necessary to fix the problem causing the fault; automatically takes any appropriate initial steps to fix the problem causing the fault; alerts the operator of the vehicle to the fault; and communicates to the operator of the vehicle any appropriate remaining steps that the operator of vehicle should take to fix the problem causing the fault.

Thus, in one aspect, once the AI system determines a fault, the AI system determines all the necessary steps to fix the fault and carries out those steps that it can automatically, alerting and involving the operator of the vehicle subsequently. For example, if the fault is low tire pressure, the AI system determines which tire and why/how (e.g., simple low pressure or persistent leak). As the AI system cannot necessarily fill the tire, the AI system identifies the nearest service station and notifies the operator of the vehicle of the problem and the proposed fix. The first priority would be to identify a drive-up service station. This may not be possible if the pressure is too low, and it may be suggested to pull over and contact a tow service to fix/fill the tire. Generally, the AI system identifies the nearest service station(s). Once the service station is identified, the AI system alerts the operator of the vehicle and provides the recommended solution (e.g., displaying location and directions). The AI system may consider various factors, such as operator appointments, availability, urgency, traffic, weather, etc. to select the best solution(s). If the selected station is a drive-up service station, then the AI system may establish a communication channel with the service station and provide information about the tire once the operator of the vehicle has accepted the recommendation.

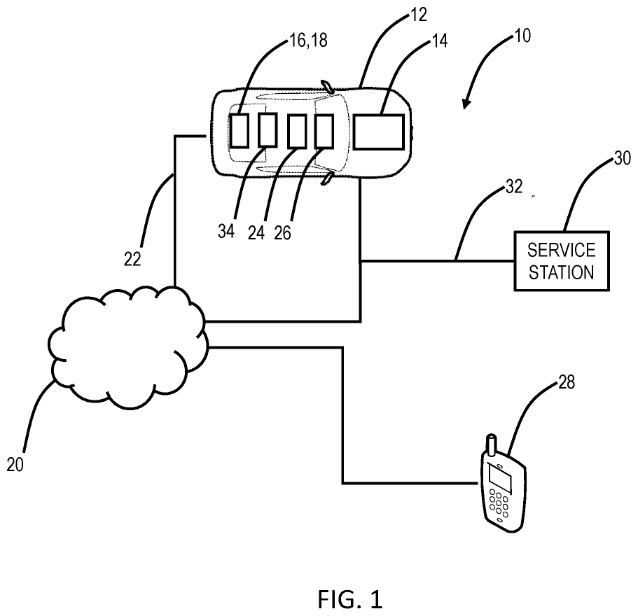

FIG. 1 is a schematic diagram illustrating one embodiment of the vehicle fault detection and mitigation system 10 of the present disclosure. In this system 10, the vehicle 12 includes various sensors 14 each operable for detecting a fault in the vehicle 12, such as detecting detect that a tire pressure is low, a fluid level is low, there is an engine issue, a headlight is malfunctioning, a safety feature is disabled, and/or the like, without limitation. Such sensors 14 may take a variety of forms, without limitation, and are well known to those of ordinary skill in the art. The vehicle 12 also includes an associated AI system 16, which may consist of instructions stored in a memory and executed by a processor, such as the ECU or other processing system 18 disposed in the vehicle 12. Alternatively, the AI system 16 may be resident in the cloud 20 and in communication with the vehicle via an appropriate network link 22. The AI system 16 is operable for identifying a fault sensed by a sensor 14 of the vehicle 12 and diagnosing one or more of a source of the fault, a nature of the fault, and a cause of the fault. For example, if the fault is a low tire pressure sensed by a tire sensor, the AI system 16 may recognize this low tire pressure fault, determine which tire has a low tire pressure, determine the actual pressure in the tire, and determine whether the likely cause is simply under-filling, a slow leak, or a more major, persistent leak. Based on these determinations, the AI system 16 is operable for retrieving or generating steps to address the problem causing the fault and controlling a vehicle system 24 to take any initial steps to address the problem causing the fault. For example, an engine fault may initially be dealt with by automatically adjusting engine operational parameters in a prophylactic manner to mitigate the engine fault to some extent, or at least prevent engine damage or a safety issue. One such automatic steps are taken, via a display 26, an operator of the vehicle 12 is notified of the fault and any remaining steps to address the problem causing the fault that should be taken by the operator of the vehicle 12 are communicated to the operator of the vehicle 12.

In general, the AI system 16 may simply use a lookup table including faults and steps to address problems causing the faults. In a more robust example, the AI system 16 is trained using a large set of faults and steps to address the problems causing the faults. Such AI training methodologies are well known to those of ordinary skill in the art, and this training process may be supervised or unsupervised.

The display 26 may include one or more of a display of the vehicle 12, such as a vehicle control display, a dashboard display, or a navigation system display, and/or a display of a mobile device 28 associated with the operator of the vehicle 12. Such display 26 may act as or be associated with an appropriate user interface (UI), graphical and/or audio, for interaction with the operator of the vehicle 12.

The AI system 16 associated with the vehicle 12 is further operable for receiving an instruction from the operator of the vehicle 12 related to carrying out a remaining step to address the problem causing the fault, via the display 26 and/or UI. After receiving the instruction from the operator of the vehicle 12 related to carrying out the remaining step to address the problem causing the fault, the AI system 16 may communicate details associated with the fault to a third party, such as a service station 30, via a communication link 32, which may be a wireless link, a network link through the cloud 20, etc.

In one aspect, communicating to the operator of the vehicle 12 a remaining step to address the problem causing the fault may include communicating to the operator of the vehicle 12 a location of a preferred service station 30 identified by the AI system 16 associated with the vehicle 12 via a navigation system 34 of one or more of the vehicle 12 and the mobile device 28. The preferred service station 30 is identified taking into account one or more of, for example, services available at the preferred service station 30, proximity of the preferred service station 30 to the vehicle 12, proximity of the preferred service station 30 to a destination of the vehicle 12 received from the operator of the vehicle, a determined severity of the fault, a determined fuel or charge range of the vehicle 12, an available time received from the operator of the vehicle 12, current road conditions, current traffic conditions, and current weather conditions.

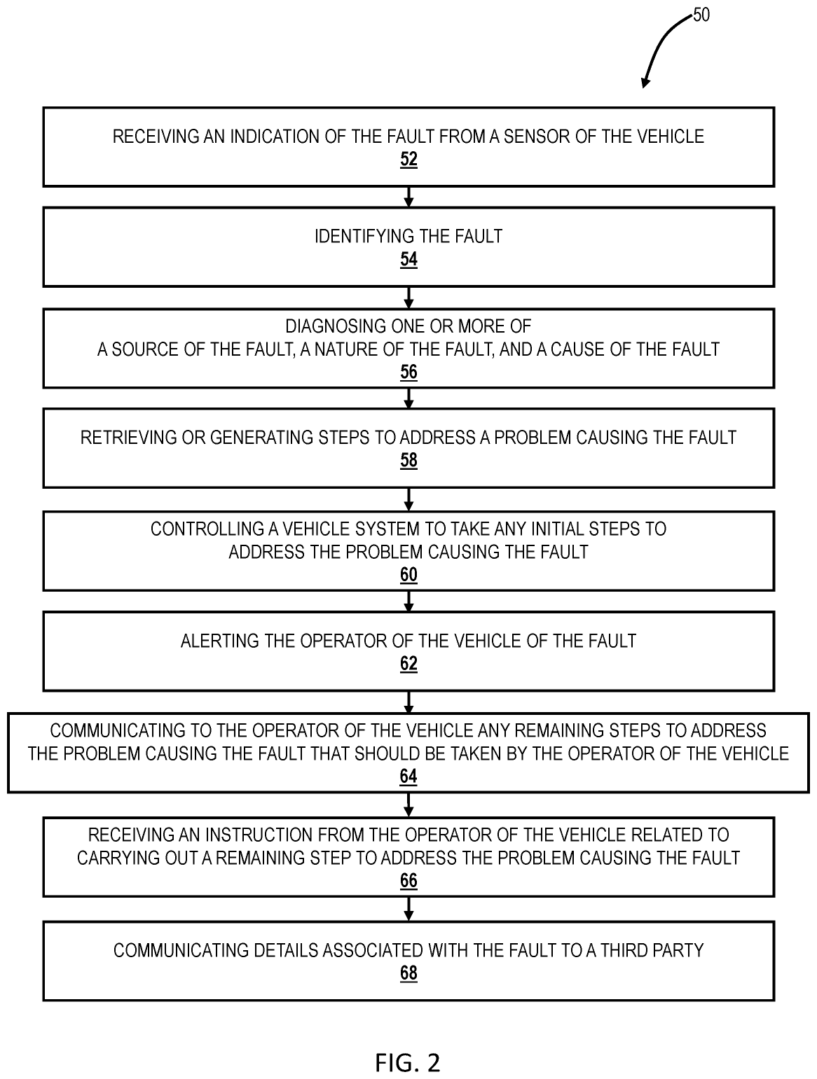

FIG. 2 is a schematic diagram illustrating one embodiment of vehicle fault detection and mitigation method 50 of the present disclosure. The method 50 includes receiving an indication of the fault from a sensor of the vehicle (step 52) and, at the AI system associated with the vehicle, identifying the fault (step 54). The method 50 also includes, at the AI system associated with the vehicle, diagnosing one or more of a source of the fault, a nature of the fault, and a cause of the fault (step 56). The method 50 further includes, at the AI system associated with the vehicle, retrieving or generating steps to address a problem causing the fault (step 58) and, at the AI system associated with the vehicle, controlling a vehicle system to take any initial steps to address the problem causing the fault (step 60). The method 50 still further includes, via the AI system associated with the vehicle and a display, alerting the operator of the vehicle of the fault (step 62) and, via the AI system associated with the vehicle and the display, communicating to the operator of the vehicle any remaining steps to address the problem causing the fault that should be taken by the operator of the vehicle (step 64). The AI system one of: uses a lookup table including faults and steps to address problems causing the faults; and is trained using faults and steps to address the problems causing the faults. The display includes one or more of a display of the vehicle and a display of a mobile device associated with the operator of the vehicle. The method 50 still further includes, at the AI system associated with the vehicle, receiving an instruction from the operator of the vehicle related to carrying out a remaining step to address the problem causing the fault (step 66). The method 50 still further includes, via the AI system associated with the vehicle, after receiving the instruction from the operator of the vehicle related to carrying out the remaining step to address the problem causing the fault, communicating details associated with the fault to a third party via a communication link (step 68).

Optionally, communicating to the operator of the vehicle a remaining step to address the problem causing the fault includes communicating to the operator of the vehicle a location of a preferred service station identified by the AI system associated with the vehicle via a navigation system of one or more of the vehicle and the mobile device. The preferred service station is identified taking into account one or more of services available at the preferred service station, proximity of the preferred service station to the vehicle, proximity of the preferred service station to a destination of the vehicle received from the operator of the vehicle, a determined severity of the fault, a determined fuel or charge range of the vehicle, an available time received from the operator of the vehicle, current road conditions, current traffic conditions, and current weather conditions.

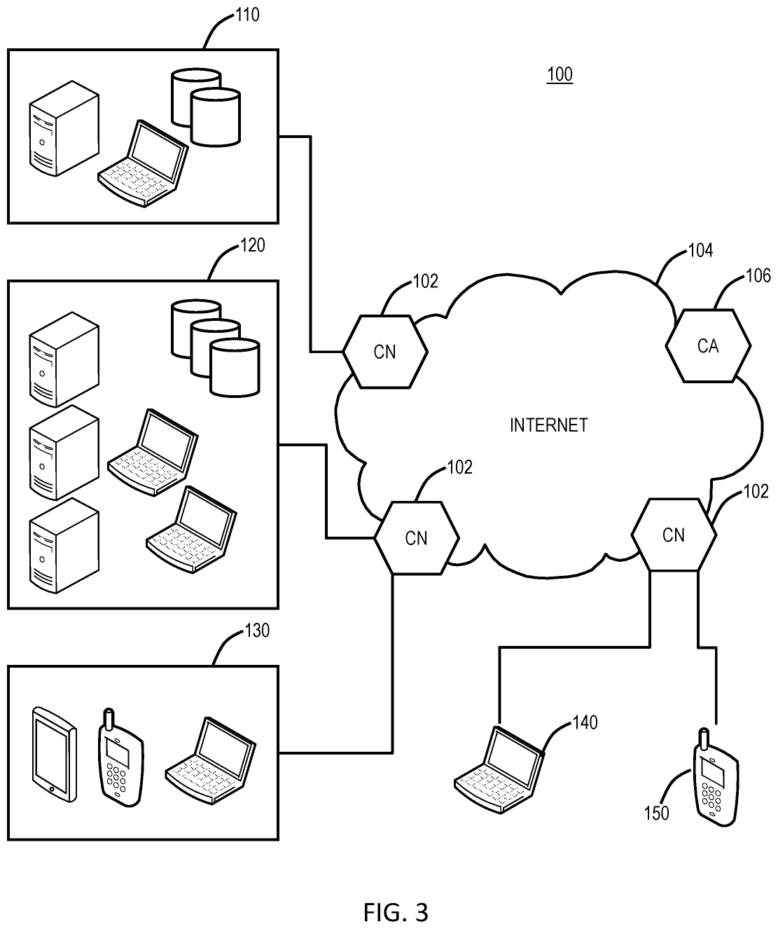

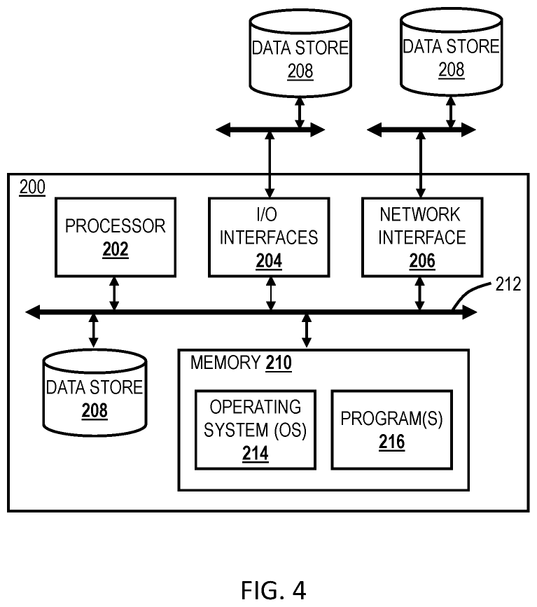

FIG. 3 is a network diagram of a cloud-based system 100 for implementing various cloud-based algorithms and functions of the present disclosure. The cloud-based system 100 includes one or more cloud nodes (CNs) 102 communicatively coupled to the Internet 104 or the like. The cloud nodes 102 may be implemented as a server 200 (as illustrated in FIG. 4) or the like and can be geographically diverse from one another, such as located at various data centers around the country or globe. Further, the cloud-based system 100 can include one or more central authority (CA) nodes 106, which similarly can be implemented as the server 200 and be connected to the CNs 102. For illustration purposes, the cloud-based system 100 can connect to a regional office 110, headquarters 120, various employee's homes 130, laptops/desktops 140, and mobile devices 150, each of which can be communicatively coupled to one of the CNs 102. These locations 110, 120, and 130, and devices 140 and 150 are shown for illustrative purposes, and those skilled in the art will recognize there are various access scenarios to the cloud-based system 100, all of which are contemplated herein. The devices 140 and 150 can be so-called road warriors, i.e., users off-site, on-the-road, etc. The cloud-based system 100 can be a private cloud, a public cloud, a combination of a private cloud and a public cloud (hybrid cloud), or the like.

The cloud-based system 100 can provide any functionality through services, such as software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the locations 110, 120, and 130 and devices 140 and 150. Previously, the Information Technology (IT) deployment model included enterprise resources and applications stored within an enterprise network (i.e., physical devices), behind a firewall, accessible by employees on site or remote via Virtual Private Networks (VPNs), etc. The cloud-based system 100 is replacing the conventional deployment model. The cloud-based system 100 can be used to implement these services in the cloud without requiring the physical devices and management thereof by enterprise IT administrators.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “software as a service” (SaaS) is sometimes used to describe application programs offered through cloud computing. A common shorthand for a provided cloud computing service (or even an aggregation of all existing cloud services) is “the cloud.” The cloud-based system 100 is illustrated herein as one example embodiment of a cloud-based system, and those of ordinary skill in the art will recognize the systems and methods described herein are not necessarily limited thereby.

FIG. 4 is a block diagram of a server 200, which may be used in the cloud-based system 100 (FIG. 3), in other systems, or stand-alone, such as in a vehicle system. For example, the CNs 102 (FIG. 3) and the central authority nodes 106 (FIG. 3) may be formed as one or more of the servers 200. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 3 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but is not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a central processing unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104 (FIG. 3). The network interface 206 may include, for example, an Ethernet card or adapter (e.g., 10BaseT, Fast Ethernet, Gigabit Ethernet, or 10 GbE) or a Wireless Local Area Network (WLAN) card or adapter (e.g., 802.11a/b/g/n/ac). The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., a SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable operating system (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable medium having computer-readable code stored thereon for programming a computer, server, appliance, device, processor, circuit, etc. each of which may include a processor to perform functions as described and claimed herein. Examples of such computer-readable mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

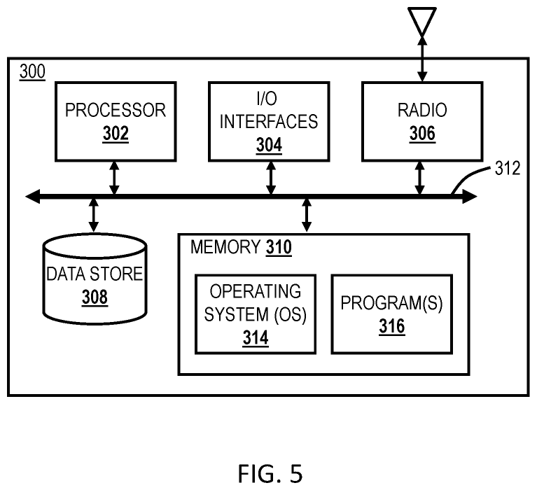

FIG. 5 is a block diagram of a user device 300, which may be used in the cloud-based system 100 (FIG. 3), as part of a network, or stand-alone, such as in a vehicle system. Again, the user device 300 can be a vehicle, a smartphone, a tablet, a smartwatch, an Internet of Things (IoT) device, a laptop, a virtual reality (VR) headset, etc. The user device 300 can be a digital device that, in terms of hardware architecture, generally includes a processor 302, I/O interfaces 304, a radio 306, a data store 308, and memory 310. It should be appreciated by those of ordinary skill in the art that FIG. 4 depicts the user device 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 can be, for example, but is not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the user device 300, a semiconductor-based microprocessor (in the form of a microchip or chipset), or generally any device for executing software instructions. When the user device 300 is in operation, the processor 302 is configured to execute software stored within the memory 310, to communicate data to and from the memory 310, and to generally control operations of the user device 300 pursuant to the software instructions. In an embodiment, the processor 302 may include a mobile optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a liquid crystal display (LCD), touch screen, and the like.

The radio 306 enables wireless communication to an external access device or network. Any number of suitable wireless data communication protocols, techniques, or methodologies can be supported by the radio 306, including any protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

Again, the memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 5, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end user functionality with the user device 300. For example, example programs 316 may include, but not limited to, a web browser, social networking applications, streaming media applications, games, mapping and location applications, electronic mail applications, financial applications, and the like. In a typical example, the end-user typically uses one or more of the programs 316 along with a network, such as the cloud-based system 100 (FIG. 3).

Again, the present disclosure provides a method and system for automatically taking an action upon detecting a fault in a vehicle. An AI system disposed in or in communication with the vehicle assists the operator of the vehicle based on a knowledge of what steps are needed when a given fault is detected in the vehicle. Some such steps may be taken before the AI system interacts with the operator of the vehicle, thereby minimizing operator effort. When a fault in the vehicle is detected, the AI system identifies the fault; diagnoses a source, nature, and cause of the fault; retrieves and/or generates steps necessary to fix the problem causing the fault; automatically takes any appropriate initial steps to fix the problem causing the fault; alerts the operator of the vehicle to the fault; and communicates to the operator of the vehicle any appropriate remaining steps that the operator of vehicle should take to fix the problem causing the fault.

Although the present disclosure is illustrated and described herein with reference to illustrative embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. A method for automatically taking an action upon detecting a fault in a vehicle, the method comprising:
receiving an indication of the fault from a sensor of the vehicle;
at an artificial intelligence system associated with the vehicle, identifying the fault;
at the artificial intelligence system associated with the vehicle, diagnosing one or more of a source of the fault, a nature of the fault, and a cause of the fault;
at the artificial intelligence system associated with the vehicle, retrieving or generating steps to address a problem causing the fault;
at the artificial intelligence system associated with the vehicle, controlling a vehicle system to take any initial steps to address the problem causing the fault;
via the artificial intelligence system associated with the vehicle and a display, alerting an operator of the vehicle of the fault; and
via the artificial intelligence system associated with the vehicle and the display, communicating to the operator of the vehicle any remaining steps to address the problem causing the fault that should be taken by the operator of the vehicle.

2. The method of claim 1, wherein the artificial intelligence system one of:
uses a lookup table including faults and steps to address problems causing the faults; and
is trained using faults and steps to address the problems causing the faults.

3. The method of claim 1, wherein the display comprises one or more of a display of the vehicle and a display of a mobile device associated with the operator of the vehicle.

4. The method of claim 1, further comprising, at the artificial intelligence system associated with the vehicle, receiving an instruction from the operator of the vehicle related to carrying out a remaining step to address the problem causing the fault.

5. The method of claim 4, further comprising, via the artificial intelligence system associated with the vehicle, after receiving the instruction from the operator of the vehicle related to carrying out the remaining step to address the problem causing the fault, communicating details associated with the fault to a third party via a communication link.

6. The method of claim 1, wherein communicating to the operator of the vehicle a remaining step to address the problem causing the fault comprises communicating to the operator of the vehicle a location of a preferred service station identified by the artificial intelligence system associated with the vehicle via a navigation system of one or more of the vehicle and a mobile device.

7. The method of claim 6, wherein the preferred service station is identified taking into account one or more of services available at the preferred service station, proximity of the preferred service station to the vehicle, proximity of the preferred service station to a destination of the vehicle received from the operator of the vehicle, a determined severity of the fault, a determined fuel or charge range of the vehicle, an available time received from the operator of the vehicle, current road conditions, current traffic conditions, and current weather conditions.

8. A non-transitory computer-readable medium comprising instructions stored in a memory and executed by a processor to carry out steps for automatically taking an action upon detecting a fault in a vehicle, the steps comprising:
receiving an indication of the fault from a sensor of the vehicle;
at an artificial intelligence system associated with the vehicle, identifying the fault;
at the artificial intelligence system associated with the vehicle, diagnosing one or more of a source of the fault, a nature of the fault, and a cause of the fault;
at the artificial intelligence system associated with the vehicle, retrieving or generating steps to address a problem causing the fault;
at the artificial intelligence system associated with the vehicle, controlling a vehicle system to take any initial steps to address the problem causing the fault;
via the artificial intelligence system associated with the vehicle and a display, alerting an operator of the vehicle of the fault; and
via the artificial intelligence system associated with the vehicle and the display, communicating to the operator of the vehicle any remaining steps to address the problem causing the fault that should be taken by the operator of the vehicle.

9. The non-transitory computer-readable medium of claim 8, wherein the artificial intelligence system one of:
uses a lookup table including faults and steps to address problems causing the faults; and
is trained using faults and steps to address the problems causing the faults.

10. The non-transitory computer-readable medium of claim 8, wherein the display comprises one or more of a display of the vehicle and a display of a mobile device associated with the operator of the vehicle.

11. The non-transitory computer-readable medium of claim 8, the steps further comprising, at the artificial intelligence system associated with the vehicle, receiving an instruction from the operator of the vehicle related to carrying out a remaining step to address the problem causing the fault.

12. The non-transitory computer-readable medium of claim 8, the steps further comprising, via the artificial intelligence system associated with the vehicle, after receiving the instruction from the operator of the vehicle related to carrying out the remaining step to address the problem causing the fault, communicating details associated with the fault to a third party via a communication link.

13. The non-transitory computer-readable medium of claim 8, wherein communicating to the operator of the vehicle a remaining step to address the problem causing the fault comprises communicating to the operator of the vehicle a location of a preferred service station identified by the artificial intelligence system associated with the vehicle via a navigation system of one or more of the vehicle and a mobile device.

14. The non-transitory computer-readable medium of claim 13, wherein the preferred service station is identified taking into account one or more of services available at the preferred service station, proximity of the preferred service station to the vehicle, proximity of the preferred service station to a destination of the vehicle received from the operator of the vehicle, a determined severity of the fault, a determined fuel or charge range of the vehicle, an available time received from the operator of the vehicle, current road conditions, current traffic conditions, and current weather conditions.

15. A system for automatically taking an action upon detecting a fault in a vehicle, the system comprising:
a sensor of the vehicle operable for sensing the fault; and
an artificial intelligence system associated with the vehicle operable for:
identifying the fault sensed by the sensor of the vehicle;
diagnosing one or more of a source of the fault, a nature of the fault, and a cause of the fault;
retrieving or generating steps to address a problem causing the fault;
controlling a vehicle system to take any initial steps to address the problem causing the fault;
via a display, alerting an operator of the vehicle of the fault; and
via the display, communicating to the operator of the vehicle any remaining steps to address the problem causing the fault that should be taken by the operator of the vehicle.

16. The system of claim 15, wherein the artificial intelligence system one of:
uses a lookup table including faults and steps to address problems causing the faults; and
is trained using faults and steps to address the problems causing the faults.

17. The system of claim 15, wherein the display comprises one or more of a display of the vehicle and a display of a mobile device associated with the operator of the vehicle.

18. The system of claim 15, wherein the artificial intelligence system associated with the vehicle is further operable for receiving an instruction from the operator of the vehicle related to carrying out a remaining step to address the problem causing the fault.

19. The system of claim 18, wherein the artificial intelligence system associated with the vehicle is further operable for, after receiving the instruction from the operator of the vehicle related to carrying out the remaining step to address the problem causing the fault, communicating details associated with the fault to a third party via a communication link.

20. The system of claim 18, wherein communicating to the operator of the vehicle a remaining step to address the problem causing the fault comprises communicating to the operator of the vehicle a location of a preferred service station identified by the artificial intelligence system associated with the vehicle via a navigation system of one or more of the vehicle and a mobile device.

21. The system of claim 20, wherein the preferred service station is identified taking into account one or more of services available at the preferred service station, proximity of the preferred service station to the vehicle, proximity of the preferred service station to a destination of the vehicle received from the operator of the vehicle, a determined severity of the fault, a determined fuel or charge range of the vehicle, an available time received from the operator of the vehicle, current road conditions, current traffic conditions, and current weather conditions.
